(19) United States
(12) Patent Application Publication
(10) Pub. No.: US 2009/0306555 A1
(43) Pub. Date: Dec. 10, 2009

(54) Massaging Apparatus

(76) Inventor: Koji Goto, Osaka-shi (JP)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/306,512

(22) PCT Filed: Jun. 20, 2007
(86) PCT No.: PCT/JP2007/062414

§ 371 Date: Dec. 23, 2008

(30) Foreign Application Priority Data
Jun. 27, 2006 (JP) 2006-176742
Jan. 26, 2007 (JP) 207-016901

(51) Int. Cl. A61H 1/00

(52) U.S. Cl. 601/15

(57) ABSTRACT

A massaging apparatus capable of applying visual stimulus to a user being massaged is provided.

A massaging apparatus 1 of the present invention comprises a hood 5 configured to cover a head part of the user supported by a body support unit; and a light emitting device 10 mounted to the hood 5. The light emitting device 10 includes a light guiding member 11 of a rod-shape provided with a fluorescent portion 11a on a peripheral surface thereof and a light source 12 configured to emit light entering an inside of the light guiding member 11 through an end surface of the light guiding member 11. The light guiding member 11 is disposed inside the hood 5.

### TECHNICAL FIELD

The present invention relates to a massaging apparatus configured to massage a body of a user. More particularly, the present invention relates to a massaging apparatus which is configured to apply visual stimulus to a user being massaged.

### BACKGROUND ART

Conventionally, as a massaging apparatus including air bags configured to expand and contract or massaging elements configured to roll, for example, there is a chair-type massaging apparatus (see patent document 1), a mattress-type massaging apparatus (see patent document 2), etc. These massaging apparatuses are configured to cause the air bags or the massaging elements to apply a physical pressing force to the user to relax muscle stiffness or to press acupressure points. In this way, the body of the user is massaged. Patent document 1: Japanese Laid-Open Patent Application Publication No. 2005-192603 Patent document 2: Japanese Laid-Open Patent Application Publication No. 2005-318938

### DISCLOSURE OF THE INVENTION

### Problems to be Solved by the Invention

As disclosed in the above identified patent documents 1 and 2, the conventional massaging apparatus is typically configured to apply a physical pressing force to the body and not to apply visual stimulus to the user. However, effects of massage for the user are expected to be improved by applying the visual stimulus to the user along with the physical stimulus applied by the massaging elements. Therefore, there has been a demand for such a massaging apparatus.

Accordingly, an object of the present invention is to provide a massaging apparatus such as a chair-type massaging apparatus or a mattress-type massaging apparatus, which is capable of applying visual stimulus to the user along with physical stimulus.

### Means for Solving the Problems

The present invention has been made under the circumstances, and a massaging apparatus of the present invention, including a body support unit which supports a body of a user and a massaging unit configured to apply pressing stimulus to the user supported by the body support unit, comprises a hood configured to cover a head part of the user supported by the body support unit; and a light emitting device provided in the hood; wherein the light emitting device includes a light guiding member having a fluorescent surface and a light source configured to emit light entering an inside of the light guiding member through an end surface of the light guiding member; and wherein the light guiding member is disposed inside the hood.

In such a configuration, both pressing stimulus and visual stimulus of the light emitting device are applied to the user. Since the light guiding member of the light emitting device is disposed inside the hood, visual stimulus from the outside world is not substantially given to the user whose head part is covered by the hood. As a result, the visual stimulus of the light emitting device is efficiently applied to the user.

The body support unit may include a seat on which the user is seated, and a back rest configured to support an upper body part of the user seated on the seat; and the hood may be provided at an upper portion of the back rest. In such a configuration, in so-called chair-type massaging apparatus, the hood can cover the head part of the user leaning against the back rest and the light emitting device provided inside thereof can apply visual stimulus efficiently.

The hood may be bowl-shaped; and the light guiding member included in the light emitting device may have a curved portion extending along an inner surface of the hood, and the fluorescent surface may be formed on an inner peripheral surface of the curved portion. For example, when a light enters a rod-shaped light guiding member in which the fluorescent surface is formed on an outer peripheral surface of the curved portion, through an end surface thereof, an amount of the light decreases toward a center region of the curved portion of the light guiding member, so that a difference in brightness is generated between the center region and other regions of the curved portion. However, as described above, by forming the fluorescent surface on the inner peripheral surface of the curved portion, reduction of brightness in the center region is suppressed, and thereby brightness in the longitudinal direction of the light guiding member is desirably made uniform.

The light guiding member may have an elongated plate shape, and may be disposed to extend rightward and leftward from a perspective of the user supported by the body support unit. In general, a person has a visual recognition range which is wider in a rightward and leftward direction than in a vertical direction. With the above configuration, therefore, visual stimulus can be applied to the user efficiently by light emission from the rod-shaped light guiding member.

The light emitting device may further include a reflecting member provided behind the light guiding member and may be configured to reflect the light from the light guiding member, and a diffusion member provided in front of the light guiding member to allow direct light from the light guiding member or reflected light from the reflecting member to pass therethrough. In such a configuration, brightness of the light which has passed through the diffusion member and is radiated to outside can be made uniform.

The light guiding member, the reflecting member, and the diffusion member included in the light emitting device may be elongated and may be disposed to extend rightward and leftward from the perspective of the user supported by the body support unit. In such a configuration, visual stimulation can be applied to the user efficiently.

The light emitting device may be configured to emit light in synchronization with an operation of the massaging unit. In such a configuration, both physical stimulus by the massaging unit and visual stimulus by the light emitting device can be applied to the user.

The massaging apparatus may further comprise a sensor configured to detect biological information of the user supported by the body support unit. The light emitting device may be configured to emit the light in synchronization with the biological information detected by the sensor. For example, the biological information is a pulse of the user, and the light emitting device may be configured to emit the light in association with the pulse.

The massaging apparatus may further comprise a reproducing device configured to reproduce music data. The light emitting device may be configured to emit the light in synchronization with the music data reproduced by the reproducing device. In such a configuration, the user can be massaged by the massaging unit while visually enjoying the light which is synchronous with desired music.

### EFFECTS OF THE INVENTION

In accordance with the present invention, a massaging apparatus, such as a chair-type massaging apparatus or a mattress-type massaging apparatus which is capable of applying visual stimulus to a user along with physical stimulus, can be provided.

### BRIEF DESCRIPTION OF THE DRAWINGS

FIG. 1 is a perspective view showing an external appearance of a massaging apparatus according to an embodiment of the present invention;

FIG. 2 is a perspective view showing an external appearance of a hood of FIG. 1;

FIG. 3 is a perspective view showing an external appearance of a light emitting device of FIG. 2;

FIG. 4 is a perspective view showing an external appearance of the light source of FIG. 3, as viewed from another direction;

FIG. 5 is a view showing a procedure for mounting the light emitting device to the hood;

FIG. 6 is a perspective view showing massaging units provided in the massaging apparatus;

FIG. 7 is a block diagram showing a configuration of the massaging apparatus;

FIG. 8 is an electric circuit diagram showing an example of a configuration of the light emitting device, a drive circuit, and a control device;

FIG. 9 is a schematic view showing another configuration of the light guiding member;

FIG. 10 is a partial perspective view of another configuration of the light emitting device, showing a state where the light emitting device is mounted to the hood from which an outer shell member is detached; and

FIG. 11 is a cross-sectional view showing a configuration of the light emitting device, taken along line XI-XI of FIG. 10.

### EXPLANATION OF REFERENCE NUMERALS

1 massaging apparatus
1a body support unit
2 Seat
3d, 3f, 3g, 4d, 25c air bag
4 foot rest
5 hood
6b front peripheral portion
10, 60 light emitting device
11, 11A to 11C, 65 light guiding member
11a fluorescent surface
11b curved portion
12, 66 light source
30 massaging mechanism
31 massaging element
32 speaker
33 reproducing device
43, 43a control device
44 pulse sensor
62 diffusion member
63 reflecting member

### BEST MODE FOR CARRYING OUT THE INVENTION

Hereinafter, embodiments of the present invention will be described with reference to the drawings.

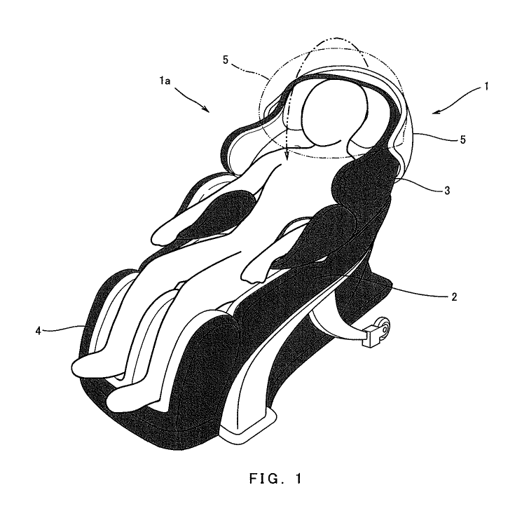

FIG. 1 is a perspective view showing an external appearance of a massaging apparatus according to an embodiment of the present invention. As shown in FIG. 1, a massaging apparatus 1 is a chair-type massaging apparatus, and includes a seat 2 on which a user is seated, a back rest 3 configured to support an upper half body part of the user, and a foot rest 4 on which feet of the user rest. In addition, a hood 5 configured to cover a head part of the user is provided at an upper part of the back rest 3. In this embodiment, the seat 2, the back rest 3, and the foot rest 4 form a body support unit 1a. As used herein, the direction is from the perspective of the user seated in the massaging apparatus 1, and the other cases are described as necessary.

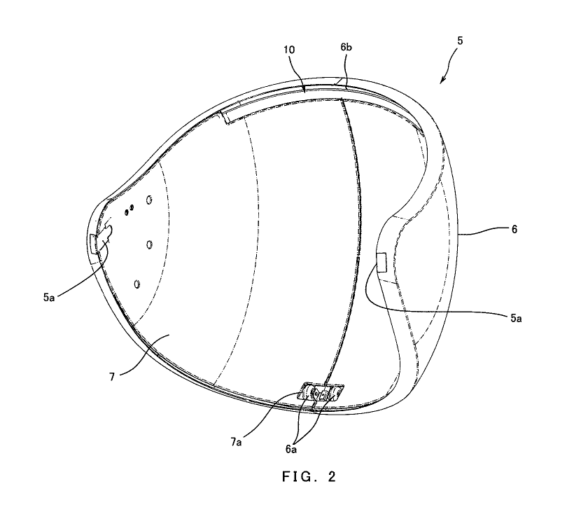

FIG. 2 is a perspective view showing an external appearance of the hood 5 of FIG. 1. The hood 5 has a substantially bowl-shape which is formed by dividing a spherical shell into four equal parts, and has an outer shell member 6 and an inner shell member 7 which have substantially the same external appearance. Bearings 5a are provided at right and left end portions of the hood 5. The bearings 5a are pivotally mounted to shafts (not shown) protruding rightward and leftward from an upper portion of the back rest 3 (see FIG. 1). Therefore, the hood 5 is rotatable around an axis extending in a rightward and leftward direction, in a state where the hood 5 is pivotally mounted to the back rest 3. The hood 5 is rotated forward so as to cover the head part of the user from above and from forward (see hood 5 illustrated in two-dotted line in FIG. 1), while the hood 5 is rotated backward so as to retract to a position behind the user (see hood 5 indicated by solid line in FIG. 1). Whereas the hood 5 is pivotally mounted to the back rest 3 in this embodiment as described above, support poles may be provided to extend vertically outside on right and left sides of the back rest 3 and the hood 5 may be pivotally mounted by shafts provided at upper portions of the support poles in a position distant from the back rest 3. Or, other configurations may be used, so long as the hood 5 is pivotally mounted in a position where the hood 5 can cover the head part of the user.

A caster 6a is attached to an inner surface of a rear portion (lower portion in FIG. 2) of the outer shell member 6. The caster 6a protrudes into an inside of the hood 5 through a rectangular hole 7a formed in a rear portion (lower portion in FIG. 2) of the inner shell member 7. The caster 6a is in contact with a rail (not shown) provided on a rear portion of the back rest 3 in a state where the hood 5 is pivotally mounted to the back rest 3. When the hood 5 is pivoted forward and backward, the caster 6a rolls on the rail. Thereby, a direct contact between the hood 5 and the back rest 3 is prevented, and the hood 5 is supported with respect to the back rest 3. The hood 5 is attached with a light emitting device 10 extending rightward and leftward along an inner surface of a front peripheral edge portion 6b of the outer shell member 6.

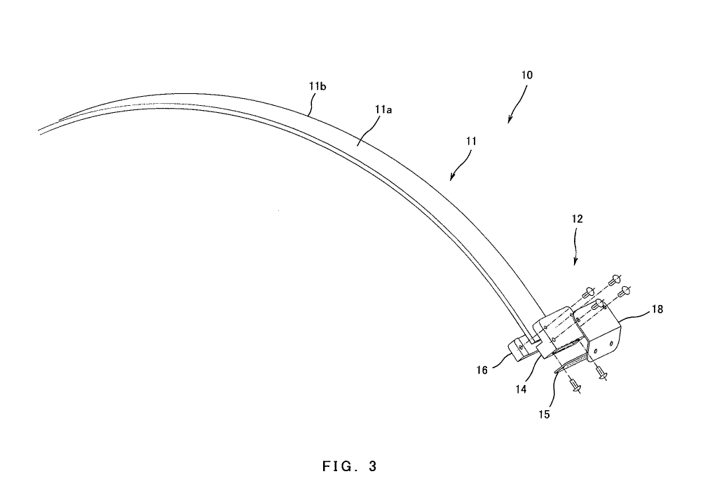

FIG. 3 is a perspective view showing an external appearance of the light emitting device 10 of FIG. 2. As shown in FIG. 3, the light emitting device 10 includes a light guiding member 11 having an elongated plate shape, and light sources 12 (only the light source 12 provided at one end portion is illustrated in FIG. 3) provided at right and left end portions of the light guiding member 11. The light guiding member 11 is molded of acrylic resin, and has a fluorescent surface 11a on a surface thereof, which is applied with a fluorescent agent uniformly.

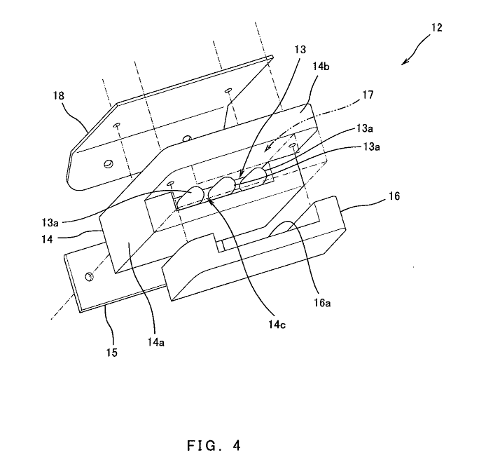

FIG. 4 is a perspective view showing an external appearance of the light source 12 of FIG. 3, as viewed from another direction. As shown in FIG. 4, the light source 12 includes a light source unit 13 having red, green, and blue LEDs 13a and a base member 14 accommodating the light source unit 13. To be more specific, the base member 14 has an accommodating portion 14a which has a substantially parallelepiped shape and has an inner space in which the light source unit 13 is accommodated, and a flange 14b which extends from an upper portion of a front surface of the accommodating portion 14a and has a thickness smaller than that of the accommodating portion 14a. A recess portion 14c is formed in a lower portion of the front surface of the accommodating portion 14a. An opening 14d is formed in a rear portion of the accommodating portion 14a to allow the light source unit 13 to be accommodated into the accommodating portion 14a therethrough. In a state where the light source unit 13 is accommodated into the accommodating portion 14a through the opening 14d, the LEDs 13a are exposed within the recess portion 14c. In this state, the opening 14d is closed by a plate 15 of a rectangular plate shape.

The light source 12 further includes a light guiding member support portion 16 which is coupled to the flange 14b of the base member 14 and is configured to support an end portion in the longitudinal direction of the light guiding member 11. The light guiding member support portion 16 has a substantially rectangular parallelepiped shape and has a recess portion 16a on an upper surface thereof. When the light guiding member support portion 16 is fastened by threaded members to the flange 14b of the base member 14, a space formed by the recess portion 14c of the base member 14 is connected to a space formed by the recess portion 16a of the light guiding member support portion 16. A support space 17 having a rectangular parallelepiped shape is formed in a region surrounded by the flange 14b and the recess portion 16a, and an end portion of the light guiding member 11 with the fluorescent surface 11a located in an upper position is inserted into the support space 17 and supported therein (see FIG. 3). As a result, the LEDs 13a of the light source 12 are opposite to an end surface of the light guiding member 11, and light emitted from the LEDs 13a enters the inside of the light guiding member 11 through the end surface thereof. The light is reflected on the fluorescent surface 11a and emanates to the outside from the light guiding member 11 through a surface which is different from the fluorescent surface 11a. A bracket 18 of a rectangular plate shape is fastened to the upper surface of the base member 14 by threaded members to fasten the light source 12 to the hood 5 (see FIG. 2).

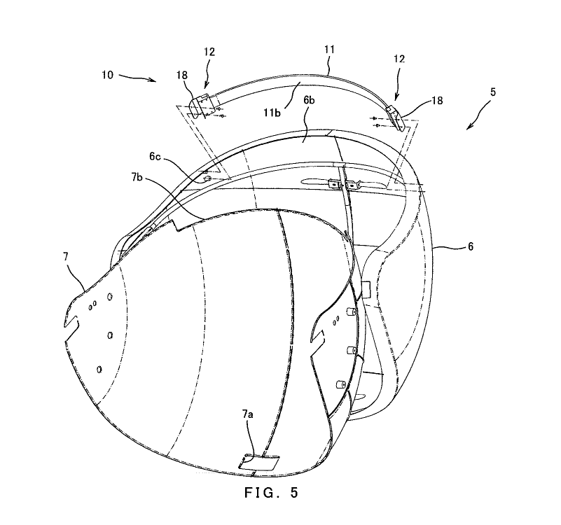

FIG. 5 is a view showing a procedure for mounting the above described light emitting device 10 to the hood 5. As shown in FIG. 5, the light emitting device 10 is placed to extend along the front peripheral edge portion 6b of the outer shell member 6 of the hood 5 in a state where the end portions of the light guiding member 11 are inserted into the support spaces 17 (see FIG. 4) of the light source 12. The light guiding member 11 has a curved portion 11b which is curved in the longitudinal direction to conform in shape to an inner surface shape of the front peripheral edge portion 6b of the outer shell member 6. The fluorescent surface 11a is positioned on an outer surface of the curved portion 11b, that is, opposite to the inner surface of the outer shell member 6. Boss portions 6c protrude from right and left sides of the inner surface of the outer shell member 6 of the hood 5. An internal thread is formed on a top portion of each of the boss portions 6c. By fastening the brackets 18 to the boss portions 6c by threaded members, the light sources 12 and the light guiding member 11 are mounted to the outer shell member 6.

A rectangular cut portion 7b having substantially the same length as the light guiding member 11 is formed in the front peripheral edge portion of the inner shell member 7. When the inner shell member 7 is mounted to the interior of the outer shell member 6 attached with the light emitting device 10, the light sources 12 are sandwiched between the outer shell member 6 and the inner shell member 7 and therefore are not exposed to outside. That is, in the light emitting device 10, only the light guiding member 11 is exposed through the cut portion 7b of the inner shell member 7 (see FIG. 2).

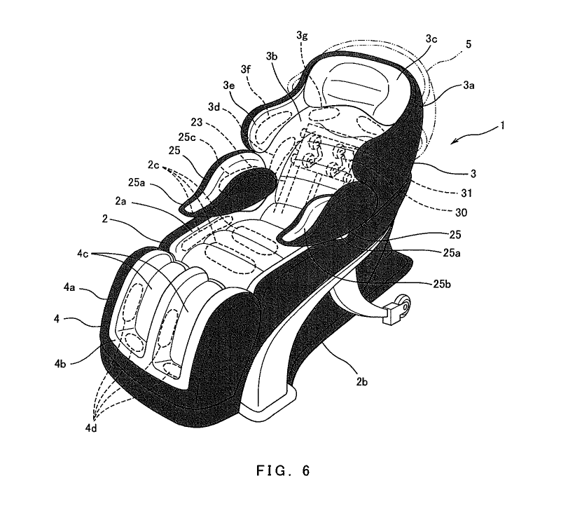

The massaging apparatus 1 includes a massaging mechanism or a plurality of air bags constituting massaging units for massaging body parts of the user with physical pressing stimulus. FIG. 6 is a perspective view showing massaging units provided in the massaging apparatus 1. In FIG. 6, the hood 5 in a retracted state is shown by two-dotted line.

As shown in FIG. 6, the seat 2 has a structure in which a cushion member 2a is provided on an upper portion of a base 2b. The base 2b is made of synthetic resin having a relatively high degree of hardness. The base 2b is inwardly recessed. The cushion member 2a includes an internal member (not shown) which is made of urethane foam, sponge, or foamed polystyrene and is placed on the inner surface of the base 2b and an outer member which is formed of polyester-made raising fabric tricot, synthetic leather, natural leather, etc., and covers the internal member. Therefore, the seat 2 has a shape for allowing a waist part and thigh parts of the user to be covered from a back portion to side portions thereof in the state where the user is seated on the seat 2. As shown in FIG. 6, a plurality of air bags 2c are provided inside the cushion member 2a of the seat 2. These air bags 2c are provided in positions respectively corresponding to back portions of the waist part, and the thigh parts of the user, i.e., a recessed inner bottom portion, and in positions respectively corresponding to side portions of the waist part and the thigh parts of the user, i.e., recessed inner side portions.

The foot rest 4 is pivotally mounted at an upper end portion thereof to a front side of an upper portion of the seat 2. Thereby, the foot rest 4 is pivotable forward and backward around the upper end portion thereof. The foot rest 4 mainly includes a cover member 4a which is inwardly recessed and a cushion member 4b provided inside the cover member 4a. The cover member 4a is made of the same material as the base 2b and is channel-shaped in a front view. The cushion member 4b provided inside the cover member 4a has two recess portions 4c which are elongated in a vertical direction. The recess portions 4c are formed slightly larger than lower legs and feet (part from ankle regions to toes) of an adult person having a general constitution. The recess portions 4c are used as portions on which feet of the user seated in the massaging apparatus 1 rest.

Each recess portion 4c includes an inner bottom portion which is opposite to a back portion of the lower legs of the user, inner side portions which are opposite to side portions of the lower legs of the user, and an inner bottom portion which is opposite to a foot sole of the user so that the recess portion 4c covers the lower legs and the foot of the user over the back portion, the side portions, and the foot sole in the state where the user is seated in the massaging apparatus 1. The cushion member 4b includes an inner member and an outer member which are identical to those of the cushion member 2a. A plurality of air bags 4d are respectively provided inside the inner bottom portion, the inner side portions, and the inner bottom portion of the cushion member 4b.

The back rest 3 is provided at a rear portion of the seat 2. The back rest 3 is pivotally mounted at a lower end portion thereof to the base 2b and is pivotable forward and backward, enabling reclining of the back rest 3. The back rest 3 may be moved such that its lower portion inserts into an inside of the seat 2 according to tilting of the back rest 3. This makes it possible to suppress an occurrence of a relative displacement between a back portion of a torso part of the user and massaging elements 31 described later.

The back rest 3 mainly includes a portion for supporting the torso part of the user and a portion for supporting the head part of the user. The entirety of back rest 3 has a unitary shape formed by the cover member 3a which is inwardly recessed. Inside the cover member 3a, a cushion member 3b for supporting the torso part of the user and a cushion member 3c for supporting the head part of the user are arranged in a lower position and an upper position, respectively. The cover member 3a is formed in a substantially rounded boat shape and is made of the same material as the base 2b. Each of the cushion members 3b and 3c includes the same inner member and outer member as the cushion member 2a.

The cushion member 3b for supporting the torso part has a shape for covering the torso part of the user from the back portion to the side portions in the state where the user is seated. A plurality of air bags 3d are provided inside the cushion member 3b. The air bags 3d are provided in positions respectively corresponding to the side portions of the torso part of the user, i.e., the recessed inner side portions. Air bags 3g are provided at upper end portions of the cushion member 3b to apply stimulus to side portions of a neck part and upper portions of a shoulder of the user.

A massaging mechanism 30 which is one of the massaging units of the massaging apparatus 1, is provided in a position inside the back rest 3 which corresponds to the back portion of the torso part of the user, i.e., the recessed inner bottom portion. The massaging mechanism 30 includes a kneading motor 30a, a tapping motor 30b, and an up-down motor 30c. The motors 30a to 30c are driven to enable the massaging elements 31 to perform a kneading operation, a tapping operation, and a rolling operation.

The cover member 3a has a portion extending forward from the cushion member 3c for supporting the head part. Inside this portion, cushion members 3e are provided. The cushion members 3e are positioned so as to cover upper arm parts and side portions of the shoulder of the user in the state where the user is seated and a plurality of air bags 3f are provided inside the cushion members 3e. Speakers 32 are provided at right and left sides of the cushion member 3c for supporting the head part and are configured to output music or the like reproduced by a reproducing device 40 described later.

Two arm rests 25 are provided in front of the back rest 3 and above both side portions of the seat 2. Each arm rest 25 includes a cover member 25a which is formed by curving a plate-shaped member in a circular-arc shape and a cushion member 25b provided inside the cover member 25a. The arm rest 25 is slightly longer than a forearm of the general adult and is configured to hold an elbow, a forearm, a hand and others of the user so as to cover them in the state where the user is seated in the massaging apparatus 1. A plurality of air bags 25c are provided inside the cushion member 25b. To be specific, the arm rest 25 is substantially U-shaped in a front view. The air bags 25c are provided in three positions which are both inner portions and an inner bottom portion of the U-shape to apply stimulus to an outer portion (portion connected to a back of the hand) of the forearm of the user, an inner side portion (portion connected to a palm of the hand) of the forearm, and a lateral side portion (portion connected to a fifth finger) of the forearm, during use.

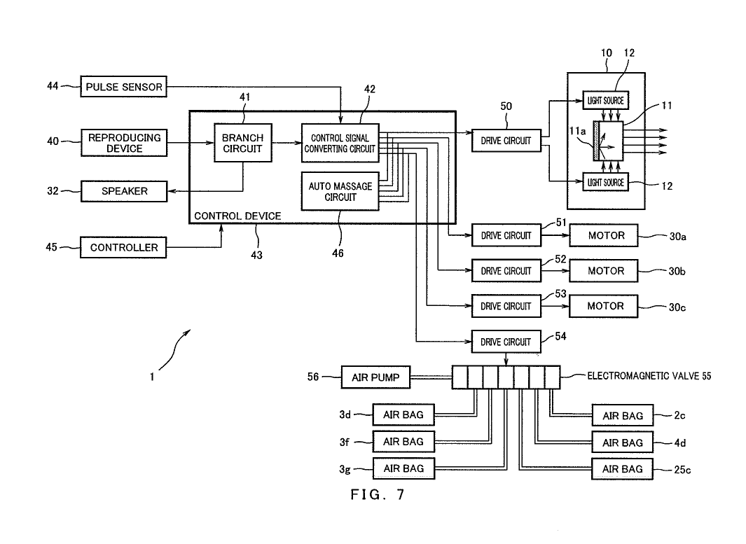

FIG. 7 is a block diagram showing a configuration of the above described massaging apparatus 1. As shown in FIG. 7, the massaging apparatus 1 includes a reproducing device 40 which is configured to reproduce an audio signal of music data or the like, a branch circuit 41 to which the audio signal output from the reproducing device 40 is input, and a control signal converting circuit 42 connected to the branch circuit 40. The branch circuit 41, the control signal converting circuit 42, and an automatic massage circuit 46 to be described later, constitute a control device 43. A controller 45 which is operated by the user is coupled to the control device 43. The reproducing device 40 includes an audio reproducing device such as a record player, a CD player, a MD player, a MIDI sound source, a tape deck, a television tuner, a radio, etc. The audio signal which is output from the reproducing device 40 and is input to the branch circuit 41 branches into a signal for the speaker 32 and a signal for the control signal converting circuit 42.

The audio signal input to the speaker 32 is converted into audio and outputted by the speaker 32. To the control signal converting circuit 42, a signal from a pulse sensor 44 included in the massaging apparatus 1 is input, in addition to the signal from the branch circuit 41. The pulse sensor 44 is attached to a finger of the user seated in the massaging apparatus 1 and is configured to detect a variation (pulse) in a blood pressure or the like within a peripheral blood vessel which is associated with the user's heartbeat, as biological information. A biological signal relating to the detected pulse is input to the control signal converting circuit 42.

The control signal converting circuit 42 converts the audio signal from the branch circuit 41 or the biological signal from the pulse sensor 44 to generate control signals, and suitably allocates the control signals to the drive circuits 50 to 54. As the control signals, the audio signal or the biological signal may be used without converting them, or only a specific frequency component obtained through a low pass filter, a band pass filter, etc., may be used. Or, a proper bias signal may be added to generate a control signal. Or, by combining these, the control signal may be attained.

Among the drive circuits 50 to 54 to which the control signals are input, the drive circuit 50 is coupled to the light sources 12 included in the light emitting device 10 and is configured to drive the light emitting device 10 based on the control signal from the control signal converting circuit 42. As a result, the light guiding member 11 of the light emitting device 10 emits light. The drive circuits 51 to 53 are coupled to the kneading motor 30a, the tapping motor 30b, and the up-down motor 30c, respectively, and are configured to drive the motors 30a to 30c based on the control signals from the control signal converting circuit 42. As a result, the massaging mechanism 30 which is one of the massaging units of the massaging apparatus 1 is driven, so that the massaging elements 31 carry out massage operations such as kneading, tapping or rolling.

The drive circuit 54 is coupled to electromagnetic valves 55 and to an air pump 56. The electromagnetic valves 55 are seven in total number. To six of these electromagnetic valves 55, the air bags 2c, 3d, 3f, 3g, 4d, and 25c (see FIG. 6) are respectively coupled via air hoses. To the remaining one electromagnetic valve 55, the air pump 56 is coupled via an air hose. The electromagnetic valves 55 are driven so that connection states between the air pump 56 and the air bags 2c, 3d, 3f, 3g, 4d, and 25c are selected as desired. One or plural of the air bags 2c, 3d, 3f, 3g, 4d, and 25c which are not connected to the air pump 56 are coupled to exhaust outlets (not shown) provided at the electromagnetic valves 55, and the remaining ones are blocked off to inhibit incoming and outgoing of air. The electromagnetic valves 55 and the air pump 56 operate based on the signal from the drive circuit 54, so that the air bags 2c, 3d, 3f, 3g, 4d, and 25c constituting the massaging unit of the massaging apparatus 1 expand and contract to carry out pressing massage to the user.

The electromagnetic valves 55 may be replaced by a rotary valve. In this case, the rotary valve having seven ports is used. One of these ports is coupled to the air pump 56 via the air hose, and the remaining six ports are coupled to the air bags 2c, 3d, 3f, 3g, 4d, and 25c. A stepping motor is built into the rotary valve. By operating the motor, connection between the ports may be switched, so that connection states between the air pump 56 and the air bags 2c, 3d, 3f, 3g, 4d, and 25c may be sequentially switched. One or plural of the air bags which are not connected to the air pump 56 may be coupled to exhaust outlets provided in the rotary valve, while the ports corresponding to the remaining air bags which are not connected to the air pump 56 may be closed. Thus, in the case where the rotary valve is used in place of the electromagnetic valves 55, the air bags 2c, 3d, 3f, 3g, 4d, and 25c constituting the massaging unit of the massaging apparatus 1 are expanded and contracted. Thus, the pressing massage is carried out with respect to the user.

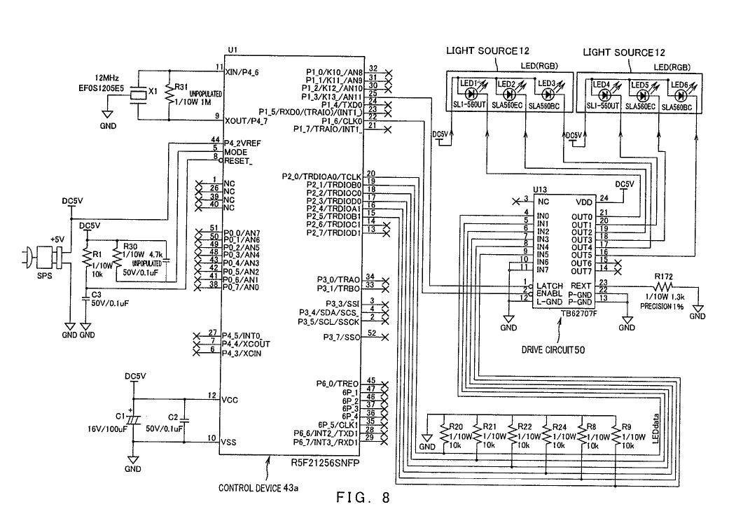

In addition to the branch circuit 41 and the control signal converting circuit 42, the control device 43 includes the automatic massage circuit 46. The automatic massage circuit 46 is configured to output a predetermined pattern drive signal selected from among a plurality of patterns, to one or plural of the drive circuits 50 to 54, based on the signal from the controller 45. To be specific, the user can select one from among a plurality of automatic massage courses, by using the controller 45. The automatic massage circuit 46 outputs a drive signal of a pattern corresponding to a course selected by the user to one or plural of the drive circuits 50 to 54, based on the signal from the controller 45. Then, the drive circuits 50 to 54 drive the light emitting device 10, the motors 30a to 30c, and the electromagnetic valves 55 based on the signals of the patterns, to carry out light emission, and massage operations such as kneading, tapping, or rolling.

Whereas in the above described example, all the drive circuits 50 to 54 are driven by using one control device 43, a control device provided for each or for plural of the plurality of drive circuits 50 to 54 may be used. For example, a control device 43a may be exclusively allocated to the drive circuit 50 for operating the light emitting device 10. An example of a circuit diagram in this case is shown in FIG. 8. In this case, as in the above described control device 43, the control device 43a may be configured to receive an input from the branch circuit 41 and an input from the pulse sensor 44.

Subsequently, an operation of the massaging apparatus 1 configured as described above will be described. As shown in FIG. 1, when the hood 5 is pivoted forward in the state where the user is seated on the seat 2 and the upper half body part is supported by the back rest 3, the head part of the user is turned to be covered with the hood 5 from above and from forward (state shown by two-dotted line in FIG. 1). At this time, the light guiding member 11 of the light emitting device 10 provided inside the hood 5 is extended rightward and leftward in front of the eyes of the user.

[Synchronization Between Massaging Unit Such as Massaging Elements or Air Bags and Light Emitting Device]

In this state, when the user operates the controller 45 (see FIG. 7) to select a specified auto massage course, the automatic massage circuit 46 outputs to the drive circuits 50 to 54, a drive signal having a pattern corresponding to this course. As a result, the light emitting device 10, the motors 30a to 30c, and the electromagnetic valves 55 operate in association with each other. Therefore, the user can receive visual stimulus generated by light emission of the light emitting device 10, in association with physical stimulus applied by the massaging elements 31 operated by the motors 30a to 30c and physical stimulus applied by the air bags 2c, 3d, 3f, 3g, 4d, and 25c operated by the electromagnetic valves 55 and the air pump 56.

The synchronization operation of the light emitting device 10 may be such that the light emitting device 10 increases or decreases the amount of light or changes a color of the light, according to the magnitude of the operation speed of the massaging unit such as the massaging elements 31, and the air bags 2c, 3d, 3f, 3g, 4d, or 25d, or the intensity of the physical stimulus applied to the user by the massaging unit. Alternatively, the color of the light may be varied in a stepwise manner (in a gradation manner) at the speed according to the operation rhythm of the massaging unit.

[Synchronization Between Audio and Operation of Light Emitting Device]

In a case where the user sets a music CD in, for example, a CD player which is the reproducing device 40 to reproduce the audio signal (music data) recorded in the music CD, the reproduced audio signal is input to the branch circuit 41 of the control device 43. The branch circuit 41 outputs the audio signal to the speaker 32 and the control signal converting circuit 42. The speaker 32 converts this audio signal into audio and outputs a sound which can be listened to by the user. The control signal converting circuit 42 outputs the drive signals to the drive circuits 50 to 54 according to the input audio signal, to drive the light emitting device 10, the motors 30a to 30c, or electromagnetic valves 55 and the air pump 56. As a result, the light emitting device 10 and the massaging unit operate in synchronization with the audio emitted from the speaker 32.

The operation of the light emitting device 10 in synchronization with the audio may be such that the light emitting device 10 increases or decreases the amount of light or changes the color of the light, according to the magnitude of the frequency of the audio or the magnitude of the amplitude. Alternatively, the color of the light may be varied in a stepwise manner (in a gradation manner) at the speed according to the operation rhythm of the massaging unit.

[Synchronization Between Biological Information and Operation of Light Emitting Device]

In a case where the user measures a pulse (biological information) using the pulse sensor 44, a biological signal indicating the pulse is input to the control signal converting circuit 42. The control signal converting circuit 42 outputs drive signals according to the input signal to the drive circuits 50 to 54. As a result, the light emitting device 10 and the massaging unit operate in synchronization with the pulse. The operation of the light emitting device 10 in synchronization with the pulse may be such that the light emitting device 10 increases or decreases the amount of light or changes the color of the light, according to the magnitude of the pulse speed.

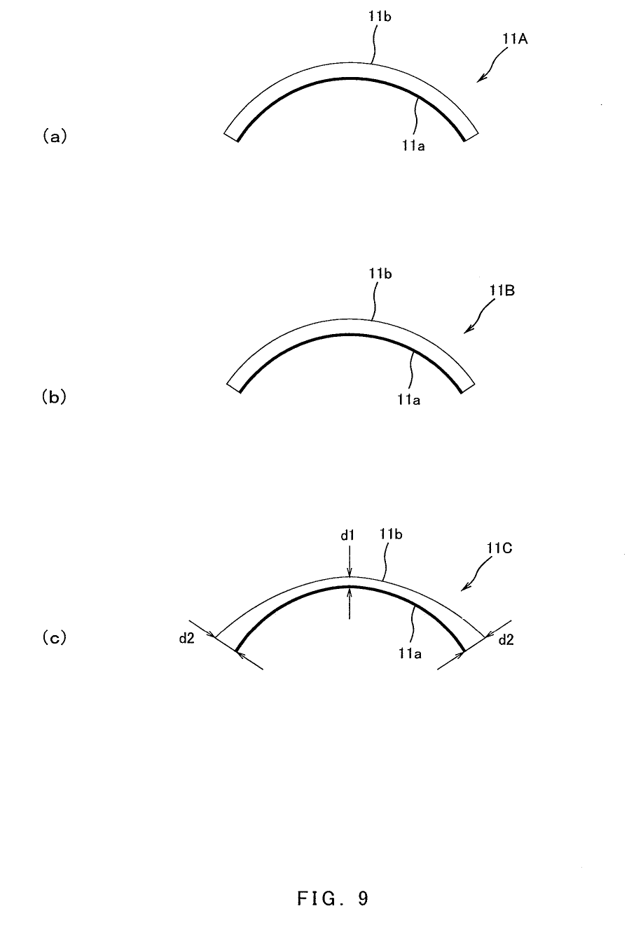

In this embodiment, as shown in FIG. 3, the light guiding member 11 which is of the straight plate shape and is made of acrylic resin is provided in the hood 5 to be curved such that the fluorescent surface 11a is located outside. However, in this state, the light tends to be darker toward a center region of the curved portion 11b of the light guiding member 11. FIG. 9 is a schematic view showing an alternation of the configuration of the light guiding member 11 which is capable of reducing the difference in brightness which is generated in the light guiding member 11.

A light guiding member 11A of FIG. 9(a) is curved such that the fluorescent surface 11a is located inside when the light guiding member 11A is disposed in the hood 5. In this case, since the light emitted from the light source 12 is reflected in a suppressed manner on a region of the fluorescent surface 11a which is in the vicinity of end portions thereof, it can reach relatively farther inside the light guiding member 11A. This makes it possible to reduce the difference in brightness in the longitudinal direction of the light guiding member 11A, achieving uniform brightness.

A light guiding member 11B of FIG. 9(b) is formed to be curved to conform in shape to the inner surface shape of the hood 5, instead of curving the plate-shaped acrylic resin as in the light guiding member 11 of FIG. 3. The light guiding member 11B is formed by cutting it out from the acrylic resin or by pouring melted acrylic resin into a die and then cooling it. When the plate-shaped acrylic resin is curved as in the light guiding member 11 of FIG. 3, a density difference is generated inside thereof, which is likely to cause a difference in brightness. Therefore, by forming the light guiding member in a curved shape in advance, the density difference generated inside the light guiding member 11B can be reduced, so that brightness can be made uniform. In the light guiding member 11B of FIG. 9(b), the fluorescent surface 11a is formed on the inner surface of the curved portion 11b, which is likely to reduce the difference in brightness.

A light guiding member 11C of FIG. 9(c) has a structure in which its thickness gradually decreases from both end regions thereof to a center region thereof so that a thickness d1 of the center region in the longitudinal direction is smaller than a thickness d2 of the both end regions thereof. In such a configuration, the light emitted from the light source 12 is reflected in a suppressed manner on a region of the fluorescent surface 11a which is in the vicinity of the end region where the light amount is large, because of its larger passage cross-sectional area, while the light emitted from the light source 12 is reflected in an accelerated manner on a region of the fluorescent surface 11a which is in the vicinity of the center region where the light amount is small, because of its smaller passage cross-sectional area. As a result, the amount of light reflected on the fluorescent surface 11a is made uniform in the center region and both the end regions so that the difference in brightness in the longitudinal direction of the light guiding member 11C is reduced. In the light guiding member 11C of FIG. 9(c), the fluorescent surface 11a is formed on the inner surface of the curved portion 11b. This may further reduce the difference in brightness.

As should be appreciated, by applying the light guiding members 11A to 11C of FIGS. 9(a) to 9(c) to the massaging apparatus 1 in place of the light guiding member 11 of FIG. 3, the difference in brightness of light which is visually recognized by the user can be reduced. As a result, the visual stimulus can be applied to the user more efficiently.

[Another Example Configuration of Light Emitting Device]

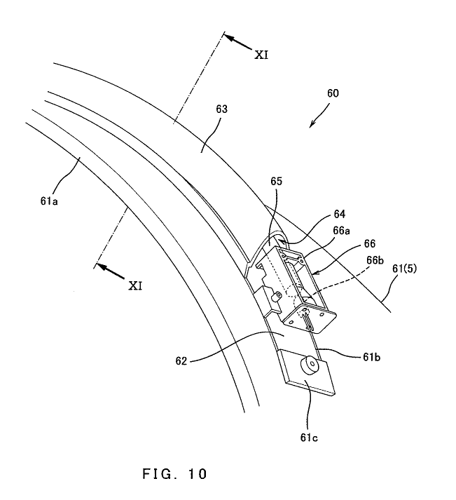

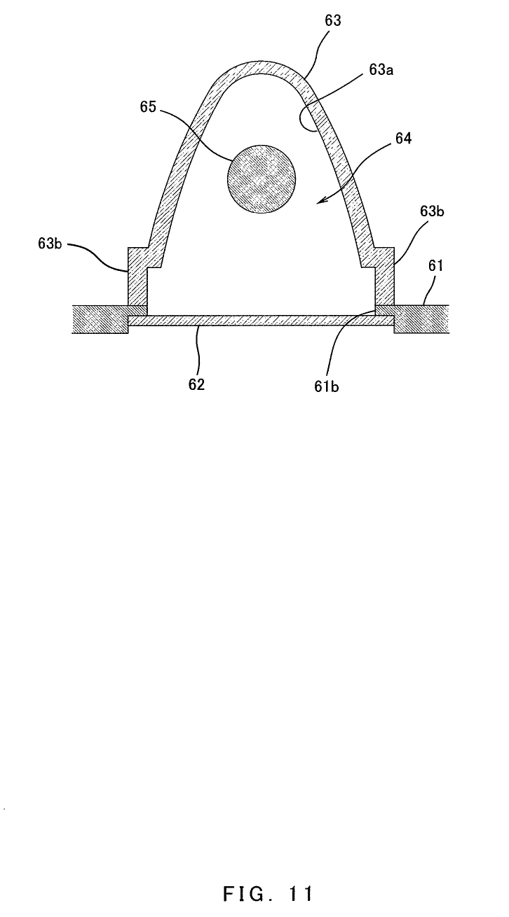

FIG. 10 is a partial perspective view of a light emitting device 60 having another configuration, showing a state where the light emitting device 60 is mounted to the hood 5 from which outer shell member 6 is detached. FIG. 11 is a cross-sectional view showing a configuration of the light emitting device 60, taken along line XI-XI of FIG. 10. As shown in FIGS. 10 and 11, the hood 5 attached with the light emitting device 60 includes an inner shell member 61 which has a different configuration from the inner shell member 7 as already described. The inner shell member 61 has an elongated slit hole 61b having a rectangular shape and extending in the vicinity of and along a front peripheral edge portion 61a.

A diffusion member 62 which has an elongated plate shape and is made of acrylic resin is fitted to the slit hole 61b from inside the inner shell member 61 (see FIG. 11). The diffusion member 62 is fastened at both end portions thereof by bolts to flanges 61c provided in the inner shell member 61 in the vicinity of the both ends of the slit hole 61b.

A reflecting member 63 is provided on the inner shell member 61 to cover the slit hole 61b from outside. The reflecting member 63 has a gutter shape formed by longitudinally dividing a pipe member having substantially the same length as the slit hole 61b. An inner surface 63a of the reflecting member 63 is smoothly curved. Step portions 63b, which are offset to outside, are formed at end portions extending in the longitudinal direction of the reflecting member 63. An end surface of each step portion 63b is connected to the inner shell member 61 in contact with an edge portion of the inner shell member 61 extending in the longitudinal direction of the slit hole 61b (see FIG. 11). In this embodiment, the reflecting member 63 is made of synthetic resin material such as polyethylene and is white-colored.

A space 64 extending along the slit hole 61b is formed between the diffusion member 62 and the reflecting member 63. A light guiding member 65 of a round rod shape is disposed in the space 64. Light sources 66 are provided in the vicinity of both end portions in the longitudinal direction of the slit hole 61b (only one light source 66 is illustrated in FIG. 10). Both end portions of the light guiding member 65 are attached to the light sources 66. As shown in FIG. 10, the light source 66 includes a substantially rectangular casing 66a, and an end portion of the light guiding member 65 is inserted into an insertion hole (not shown) formed in the casing 66a. A full-color LED 66b is accommodated in the casing 66a. The full-color LED 66b is opposite to an end surface of the light guiding member 65 inserted into the casing 66a. In this embodiment, the full-color LED 66b capable of full-color light emission by controlling light intensity of three primary colors is employed in this embodiment, three single-color LEDs capable of emitting three primary colors may alternatively be provided.

In accordance with the light emitting device 60 configured as described above, the light emitted from the full-color LED 66b enters the light guiding member 65 through an end surface thereof, propagates through an inside thereof, and is radiated to outside. A part (direct light) of the radiated light is radiated to outside (inside of the hood 5) through the diffusion member 62, while other part (reflected light) is reflected on a curved inner surface 63a of the reflecting member 63 and is radiated to outside through the diffusion member 62. Since the light is diffused in many directions while passing through the diffusion member 62, brightness in the longitudinal direction of the diffusion member 62 is made uniform, so that color unevenness which would be visually recognized is suppressed.

If the reflecting member 63 is formed of a colorless mirror material, color unevenness during light emission (nonuniformity in brightness in the longitudinal direction of the diffusion member 62) as viewed from inside the hood 5 is noticeably observed. For this reason, in this embodiment, the white-colored reflecting member 63 is employed. The diffusion member 62 is not subjected to a crimp process. This is because, if crimps are provided on the surface of the diffusion member 62 (in particular, on the surface facing the light guiding member 65), the light is irregularly reflected, increasing a loss. As a result, brightness is entirely lowered.

In order to further improve the intensity of the light radiated to inside the hood 5 through the diffusion member 62, a LED with higher brightness may be used or a white-colored fluorescent paint may be applied to the surface of the reflecting member 63 to form a fluorescent surface.

While the chair-type massaging apparatus 1 is described above, the present invention is not limited to this but may be applied to, for example, a mattress-type massaging apparatus. In this case, the hood 5 may be provided so as to cover the head part of the user in the mattress-type massaging apparatus.

### INDUSTRIAL APPLICABILITY

The present invention is applicable to a chair-type massaging apparatus or a mattress-type massaging apparatus, and is applicable to a massaging apparatus capable of applying visual stimulus to a user being massaged.

1. A massaging apparatus including a body support unit which supports a body of a user and a massaging unit configured to apply pressing stimulus to the user supported by the body support unit, comprising:
a hood configured to cover a head part of the user supported by the body support unit; and
a light emitting device provided in the hood;
wherein the light emitting device includes a light guiding member and a light source configured to emit light entering an inside of the light guiding member through an end surface of the light guiding member; and
wherein the light guiding member is disposed inside the hood.

2. The massaging apparatus according to claim 1,
wherein the body support unit includes a seat on which the user is seated, and a back rest configured to support an upper body part of the user seated on the seat; and
wherein the hood is provided at an upper portion of the back rest.

3. The massaging apparatus according to claim 1,
wherein the hood is bowl-shaped; and
wherein the light guiding member included in the light emitting device has a curved portion extending along an inner surface of the hood, and a fluorescent surface may be formed on an inner peripheral surface of the curved portion.

4. The massaging apparatus according claim 1,
wherein the light guiding member has an elongated plate shape, and is disposed to extend rightward and leftward from a perspective of the user supported by the body support unit.

5. The massaging apparatus according to claim 1,
wherein the light emitting device further includes a reflecting member provided behind the light guiding member and is configured to reflect the light from the light guiding member, and a diffusion member provided in front of the light guiding member to allow direct light from the light guiding member or reflected light from the reflecting member to pass therethrough.

6. The massaging apparatus according to claim 5, wherein the light guiding member, the reflecting member, and the diffusion member included in the light emitting device are elongated and are disposed to extend rightward and leftward from the perspective of the user supported by the body support unit.

7. The massaging apparatus according to claim 1, wherein the light emitting device is configured to emit light in synchronization with an operation of the massaging unit.

8. The massaging apparatus according to claim 1, further comprising:
a sensor configured to detect biological information of the user supported by the body support unit;
wherein the light emitting device is configured to emit the light in synchronization with the biological information detected by the sensor.

9. The massaging apparatus according to claim 1, further comprising:
a reproducing device configured to reproduce music data;
wherein the light emitting device is configured to emit the light in synchronization with music data reproduced by the reproducing device.
